(19) United States
(12) Patent Application Publication
(10) Pub. No.: US 2002/0033943 A1
(43) Pub. Date: Mar. 21, 2002

(54) Device and method for the optical inspection, assessment, and control of colored plastic articles and/or container contents

(76) Inventors: Horst Clauberg, North Wales, PA (US); David Paul Fischer, Kingsport, TN (US); Robert Noah Estep, Kingsport, TN (US); Michael Eugene Donelson, Gray, TN (US)

Correspondence Address: Karen A. Harding, Eastman Chemical Company, P.O. Box 511, Kingsport, TN, 37662-5075, US

(21) Appl. No.: 09/935,924

(22) Filed: Aug. 23, 2001

Related U.S. Application Data
(60) Provisional application No. 60/233,462, filed on Sep. 19, 2000.

(51) Int. Cl. G01N 21/00

(52) U.S. Cl. 356/240.1

(57) ABSTRACT

The present invention relates to an apparatus and method for detecting defects in colored articles. Specifically, the present invention comprises exposing a plastic colored article to radiation in the near infrared range; measuring radiation returned from or passed through said article and analyzing said returned or passed radiation to provide defect data for said article or contents within said article.

### RELATED APPLICATIONS

This application claims the benefit of U.S. Provisional Application Serial No. 60/233,462 filed Sep. 19, 2000.

### FIELD OF THE INVENTION

The present invention relates to imaging devices that can be used to show defects in darkly colored plastic articles and darkly colored contents in plastic articles.

### BACKGROUND OF THE INVENTION

A need exists in the plastics industry to provide quality assessment and quality control of defects in colored plastic articles and also in inspection of plastic container contents. Current devices and methods based on visible inspection by humans and other techniques, using cameras that operate at wavelengths between 400 nm and 700 nm, must use very high intensity light to show defects or lack thereof in colored articles, especially those articles that are darkly colored. It is also not easy to detect fill height levels in darkly colored containers. In addition, foreign objects or other undesired objects in dark beverages packaged in transparent containers cannot be readily viewed by currently available techniques.

Electrophysics of Fairfield, N.J. sells Micron Viewer Infrared Viewing TV Cameras. The technical note for MicronViewer 7290 IR viewers, page 4, notes that “objects and materials which are opaque to visible light are transparent to longer wavelength near infrared radiation”. However, only evaluation of silicon and gallium arsenide wafers and germanium containing articles are disclosed.

U.S. Pat. No. 5,729,340 discloses a container inspection device for checking the contour, type and color of a bottle using an arrangement of mirrors. A method for inspecting darkly colored bottles for defects is not disclosed.

U.S. Pat. No. 4,692,799 discloses a device for inspecting transparent polyethylene sheet using a halogen lamp. U.S. at. No. 4,988,875 discloses a near infrared inspection system for clear polyethylene cable jackets.

U.S. Pat. No. 6,067,155 discloses a near infrared inspection device for transparent glass containers.

### BRIEF SUMMARY OF THE INVENTION

The present invention relates to device for assessment and/or quality control of defects in colored articles. The device and method may also be used to inspect container contents. The device consists of a camera that is sensitive to both visible and near infrared light covering a wavelength range of about 400 nm to about 1000 nm and a monitor to display the image. An optical filter that blocks the visible wavelengths but transmits near infrared wavelengths can be used on the camera to provide greater contrast and easier identification of defects in articles and inspection of container contents. The device has been successfully used to identify bubbles, crystalline haze, and particulates in polyethylene terephthalate amber performs. The device has also been used to visualize fill height of a colored container and inspect the contents of a darkly colored beverage in a clear polyethylene terephthalate container.

Specifically, the present invention relates to a method comprising: exposing a plastic colored article to radiation in the near infrared range; measuring radiation returned from or passed through said article and analyzing said returned or passed radiation to provide defect data for said article or contents within said article.

### BRIEF DESCRIPTION OF THE FIGURES

FIG. 1 is a photograph of a defect-free amber colored polyethylene terephthalate preform. The photograph was taken by a camera with a near infrared blocking, visible transmitting filter.

FIG. 2 is a photograph of the preform photographed in FIG. 1 using a camera with a visible blocking, near infrared transmitting filter.

FIG. 3 is a photograph of an amber preform taken with a near infrared blocking, visible transmitting filter and no defects are visible.

FIG. 4 is a photograph of the amber preform shown in FIG. 3 using a camera with a visible blocking, near infrared transmitting filter. Particulate defects are clearly visible.

FIG. 5 is a photograph of two amber-colored polyethylene terephthalate performs using a camera with a near infrared blocking, visible transmitting filter.

FIG. 6 is a photograph of the amber-colored polyethylene terephthalate performs shown in FIG. 5, using a camera with a visible blocking, near infrared transmitting filter. The preform on the left in the bottom image is clear while the preform on the right shows crystalline haze.

FIG. 7 is a photograph of an amber preform containing haze using a camera with a near infrared blocking, visible transmitting filter.

FIG. 8 is a photograph of the amber preform in FIG. 7 using a camera with a visible blocking, near infrared transmitting filter. Crystalline haze is clearly visible as a milky haze in the preform.

FIG. 9 is a photograph of a black personal care container taken using a camera with a near infrared blocking, visible transmitting filter.

FIG. 10 is a photograph of the black personal care container shown in FIG. 9 taken using a camera with a visible blocking, near infrared transmitting filter. In FIG. 10 the container appears clear and transparent. In addition, the fill height of the water inside the container is visible.

FIG. 11 is a schematic drawing of the apparatus of the present invention.

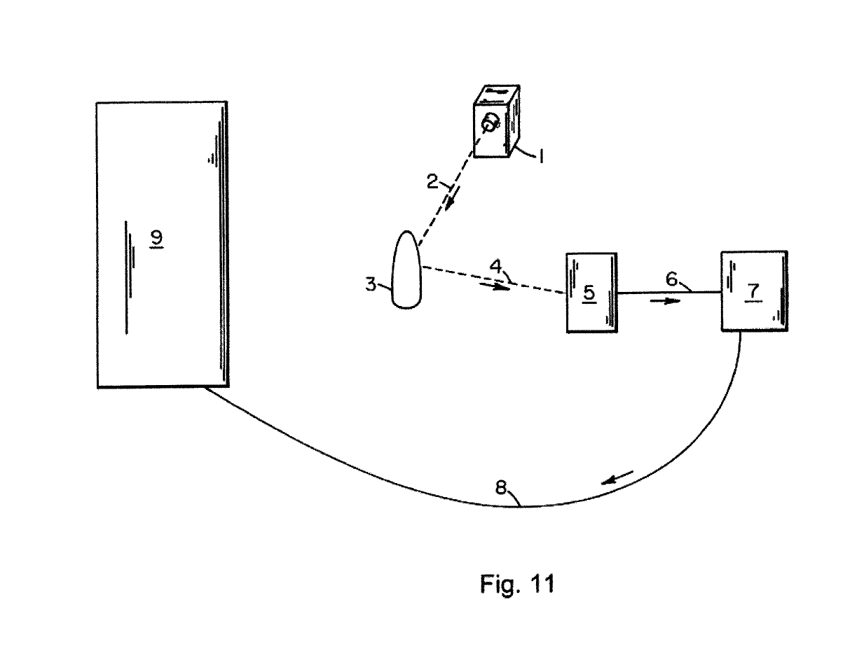

### DETAILED DESCRIPTION

The present invention relates to an apparatus for detecting defects in highly colored articles. The apparatus of the present invention may also be used for quality control and may be connected back to the molding equipment to provide real time control and adjustment of the molding conditions. The apparatus of the present invention may also be used to detect and/or control the fill level of the contents of colored containers.

The present invention also relates to a method for detecting and/or controlling defects in colored articles. The method of the present invention may also be used to detect and/or control the fill level of the contents of colored containers.

Defects include, but are not limited to crystalline haze, unmelted polymer, air bubbles, voids, foreign particulates, black specks, termination of internal layers in a multilayer structure, holes in internal layers in a multilayer structure, content fill level, foreign objects in contents and other undesired anomalies. Defects have a negative impact on performance properties and part quality. The method and apparatus of the present invention are particularly useful when inspecting articles or contents of articles that to the human eye appear dark and are difficult to inspect by a person or an optical device sensitive in the visible range (about 400 nm to about 700 nm). For the purposes of this invention colored means transmitting less than about 25% of light across the range of about 400 nm to about 700 nm (the visible range) at the thickness being measured. For further clarity, transmission across the visible range means the average transmission value across the range of about 400 nm to about 700 nm. Thus, an article having 100% transmission from 400 to 500 nm and 50% transmission from 500 to 700 nm would have an average transmission across the range of about 67%. The method and apparatus of this invention are particularly useful for articles with very low % transmissions as these articles are the hardest to evaluate by convention methods. Accordingly, articles having % transmissions of less than about 20% and less than about 15% are particularly benefited by the present invention. It should be appreciated that there is no lower limit on the % transmission in the visible range for articles which can be evaluated using the present invention, however, the articles must have some transmission, preferably at least about 10%, in at least a portion of the near infrared region. Percent transmission can be measured using a HunterLab UltraScan Colorimeter running the HunterLab Universal Software (Version 3.8) and using a D65 light source (daylight, 6500° K color temperature).

Articles which may be evaluated using the method and apparatus of the present invention include but are not limited to: pellets, reactor strands, reactor contents, parison, performs, bottles, containers, film, sheet, fibers, thermoformed articles, injection molded parts, extruded profiles, pipe, other plastics articles and even container contents such as colas, teas, coffee, other beverages, motor oil, jellies, soy sauce and the like. Any container contents which have sufficient transmission in the range of the apparatus may be imaged in accordance with the present invention. For container contents it should be appreciated that the percent solids of the contents as well as the absorption will effect transmission. In addition, the device and method are useful for inspection of container contents. Inspection of container contents is useful for verification and control of desired fill height. In addition to controlling and verifying fill height, the device can be used to inspect container contents for contamination, foreign objects, or a measure of homogeneity or lack thereof.

Articles of the present invention may be made from a variety of plastics which have the transmission properties described above. Suitable plastics include polyesters, polyolefins, polyamides, nylons, polycarbonates, polystyrenes, ethylene-vinyl acetate copolymer (EVOH), polyalcohol ethers, wholly aromatic polyesters, resorcinol diacetic acid-based copolyesters, polyalcohol amines, isophthalate containing polyesters, PEN and its copolymers and mixtures, copolymers and multilayers thereof and the like which have the light transmission properties described above. In embodiments where articles are meant for food contact polyesters are preferred. The materials may include any of a wide variety of colorants, which are known in the art.

Suitable polyamides include partially aromatic polyamides, aliphatic polyamides, wholly aromatic polyamides and mixtures thereof. By “partially aromatic polyamide” it is meant that the amide linkage of the partially aromatic polyamide contains at least one aromatic ring and a nonaromatic species.

Suitable polyamides have a film forming molecular weight and preferably an I.V. of greater than about 0.4. Wholly aromatic polyamides comprise in the molecule chain at least about 70 mole % of structural units derived from m-xylylene diamine or a xylylene diamine mixture comprising m-xylylene diamine and up to about 30% of p-xylylene diamine and an α, ω-aliphatic dicarboxylic acid having 6 to 10 carbon atoms, which are further discribed in Japanese Patent Publications No. 1156/75, No. 5751/75, No. 5735/75 and No. 10196/75 and Japanese Patent Application Laid-Open Specification No. 29697/75.

Polyamides formed from isophthalic acid, terephthalic acid, cyclohexanedicarboxylic acid, meta- or para-xylylene diamine, 1,3- or 1,4-cyclohexane(bis)methylamine, aliphatic diacids with 6 to 12 carbon atoms, aliphatic amino acids or lactams with 6 to 12 carbon atoms, aliphatic diamines with 4 to 12 carbon atoms, and other generally known polyamide forming diacids and diamines can be used. The low molecular weight polyamides may also contain small amounts of trifunctional or tetrafunctional comonomers such as trimellitic anhydride, pyromellitic dianhydride, or other polyamide forming polyacids and polyamines known in the art.

Preferred partially aromatic polyamides include: poly(m-xylylene adipamide), poly(hexamethylene isophthalamide), poly(hexamethylene adipamide-co-isophthalamide), poly(hexamethylene adipamide-co-terephthalamide), and poly(hexamethylene isophthalamide-co-terephthalamide) and the like. The most preferred partially aromatic polyamide is poly(m-xylylene adipamide).

Preferred aliphatic polyamides include poly(hexamethylene adipamide) and poly(caprolactam) and the like. The most preferred aliphatic polyamide is poly(hexamethylene adipamide). Partially aromatic polyamides, are preferred over the aliphatic polyamides where good thermal properties are crucial.

Preferred aliphatic polyamides include polycapramide (nylon 6), poly-aminoheptanoic acid (nylon 7), poly-aminonanoic acid (nylon 9), polyundecane-amide (nylon 11), polyaurylactam (nylon 12), polyethylene-adipamide (nylon 2,6), polytetramethylene-adipamide (nylon 4,6), polyhexamethylene-adipamide (nylon 6,6), polyhexamethylene-sebacamide (nylon 6,10), polyhexamethylene-dodecamide (nylon 6,12), polyoctamethylene-adipamide (nylon 8,6), polydecamethylene-adipamide (nylon 10,6), polydodecamethylene-adipamide (nylon 12,6) and polydodecamethylene-sebacamide (nylon 12,8).

Suitable polycarbonates inlcude partially aromatic polycarbonates, aliphatic polycarbonates, wholly aromatic polycarbonates and mixtures thereof. By “partially aromatic polycarbonate” it is meant that the carbonate linkage of the partially aromatic polycarbonate contains at least one aromatic ring and a nonaromatic species.

Polycarbonates formed from phosgene or a phosgene equivalent and aromatic or aliphatic diols or mixtures thereof can be used. By “phosgene equivalent” it is meant a compound which upon reaction with two equivalents of an alcohol provides a carbonate linkage. Examples of phosgene equivalents include triphosgene and diphenyl carbonate. Preferred examples of aromatic or aliphatic diols include, but are not limited to bisphenol A, bisphenol E, bisphenol F, bisphenol M, bisphenol P, bisphenol S, bisphenol Z, C₂-C₂₀ aliphatic diols including ethylene glycol, propylene glycol, butylene glycol, and the like. More preferred examples of aromatic or aliphatic diols include bisphenol A and bisphenol S.

Suitable polystyrenes include polymers formed from styrene, alpha methyl styrene and the like and are manufactured by an addition polymerization process, which is well known in the art. General purpose polystryene is often referred to as crystal polystyrene which refers to the clarity of the polymer and not its morphology. Suitable polystyrenes include “crystal styrene” which is pure atactic styrene (FINACRYSTAL), to rubber modified systems like styrene-butadiene-styrene (SBS) rubbers (K-resin and FINACLEAR), sydiotactic polystryrene, and lower rubber modified systems like high impact polystyrene (HIPS). Polystyrenes are commercially available from a number of companies including, but not limited to Dow Chemical (STYRON polystyrenes) and Nova Chemicals (NAS, ZYLAR polystyrenes and crystal and impact polystyrene). Any grade suitable for packaging may be used.

The saponified ethylene-vinyl acetate copolymer (hereinafter referred to as “EVOH”) is a polymer prepared by saponifying an ethylene-vinyl acetate copolymer having an ethylene content of 15 to 60 mole % up to a degree of saponification of 90 to 100%. The EVOH copolymer should have a molecular weight sufficient for film formation, and a viscosity of generally at least 0.01 dl/g, especially at least 0.05 dl/g, when measured at 30° C. in a phenol/water solvent (85:15).

Suitable polyalcohol ethers include the phenoxy resin derived from reaction of hydroquinone and epichlorohydrin as described in U.S. Pat No. 4,267,301 and U.S. Pat. No. 4,383,101. These materials can also contain resorcinol units and may in fact be all resorcinol units as opposed to hydroquininone units for the aromatic residue.

Suitable wholly aromatic polyesters (frequently called liquid crystalline polymers or LCPs) are formed from repeat units comprising terephthalic acid, isophthalic acid, dimethyl-2,6-naphthalenedicarboxylate, 2,6-naphthalenedicarboxylic acid, hydroquinone, resourcinol, biphenol, bisphenol A, hydroxybenzoic acid, hydroxynaphthoic acid and the like.

Suitable diacetic resorcinol copolymers are described in U.S. Pat. No. 4,440,922 and U.S. Pat. No. 4,552,948 and consist of copolyesters of terephthalic acid, ethylene glycol and a modifying diacid from 5 to 100 mol % in the composition replacing terephthalate units. The modifying diacid is either m-phenylenoxydiacetic acid or p-phenylenoxydiacetic. Either one of these diacids can be employed either by themselves or as mixtures in preparation of the copolyesters.

Suitable polyalcohol amines include those derived from reaction of either resorcinol bisgylcidyl ether with an alkanol amine, such as ethanolamine, or hydroquinone bisglycidyl ether with an alkanol amine. Mixtures of these bisglycidyl ethers can obviously also be used in preparation of a copolymer.

Suitable isophthalate containing polyesters, include polyesters comprising repeat units derived from at least one carboxylic acid comprising isophthalic acid (preferably at least 10 mole %) and at least one glycol comprising ethylene glycol.

Suitable PEN and PEN copolymers include polyesters comprising repeat units derived from at least one carboxylic acid comprising naphthalene dicarboxylic acid (preferably at least 10 mole %) and at least one glycol comprising ethylene glycol.

Suitable polyesters are generally known in the art and may be formed from aromatic dicarboxylic acids, esters of dicarboxylic acids, anhydrides of dicarboxylic esters, glycols, and mixtures thereof. As used herein, the term “repeat units from dicarboxylic acid” repeat units from the esters and anhydrides of said dicarboxylic acids. Suitable partially aromatic polyesters are formed from repeat units comprising terephthalic acid, dimethyl terephthalate, isophthalic acid, dimethyl isophthalate, dimethyl-2,6-naphthalenedicarboxylate, 2,6-naphthalenedicarboxylic acid, 1,2-, 1,3- and 1,4-phenylene dioxydoacetic acid, ethylene glycol, diethylene glycol, 1,4-cyclohexane-dimethanol, 1,4-butanediol, and mixtures thereof.

Preferred the structural polyesters comprise repeat units comprising terephthalic acid, dimethyl terephthalate, isophthalic acid, dimethyl isophthalate, dimethyl-2,6-naphthalenedicarboxylate and mixtures thereof. More preferably the polyesters used in the structural layer comprise at least about 50 mol % and most preferably at least about 70 mol % terephthalic acid in the dicarboxylic acid component.

The dicarboxylic acid component of the polyester may optionally be modified with one or more different dicarboxylic acids (up to about 30 mol % and more preferably up to about 20 mol %). Such additional dicarboxylic acids include aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. Examples of dicarboxylic acids to be included with terephthalic acid are: phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid, sebacic acid, mixtures thereof and the like.

Preferably the glycol component comprises ethylene glycol. The glycol component may optionally be modified with one or more different diols other than ethylene glycol (preferably up to about 20 mole %). Such additional diols include cycloaliphatic diols preferably having 6 to 20 carbon atoms or aliphatic diols preferably having 3 to 20 carbon atoms. Examples of such diols include: diethylene glycol, triethylene glycol, tetramethylene glycol, polytetramethylene glycol, 1,4-cyclohexanedimethanol, propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane, hydroxyethyl resorcinol, mixtures thereof and the like. Polyethers, such as unsubstituted poly(alkylene glycol)s having alkylene chains of 1 to 3 carbon atoms, substituted or unsubstituted poly(alkylene glycol)s having alkylene chains of at least 4 carbon atoms, copolymers of poly(alkylene glycol)s and blends containing poly(alkylene glycol)s, may also be included. Polyesters may be prepared from two or more of the above diols. PET is a preferred resin for many packaging applications, such as stretch blow molded containers.

The resin may also contain small amounts of trifunctional or tetrafunctional comonomers such as trimellitic anhydride, trimethylolpropane, pyromellitic dianhydride, pentaerythritol, and other polyester forming polyacids or polyols generally known in the art.

Polyesters can be made by conventional processes all of which are well known in the art, and need not be described here.

The polymers of the present invention may contain additional additives or components. Suitable additives include, but are not limited to nucleating agents, branching agents, colorants, pigments, fillers, antioxidants, ultraviolet light and heat stabilizers, impact modifiers, reheat improving aids, crystallization aids, acetaldehyde reducing additives, oxygen scavenging compounds, barrier improving additives and the like.

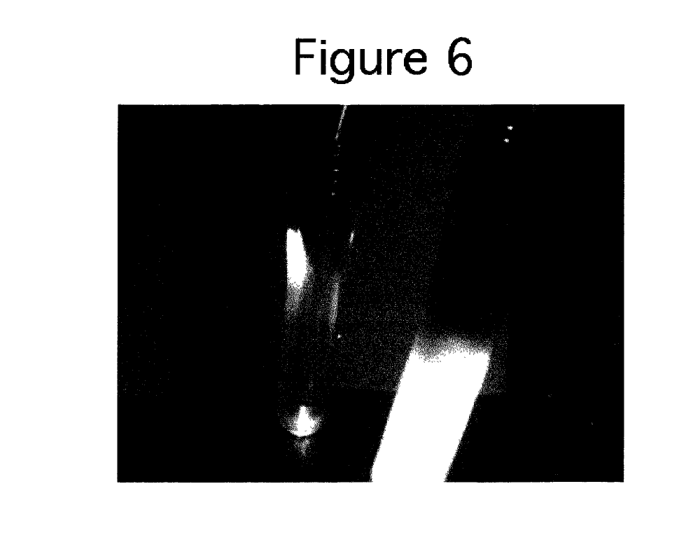

The apparatus of the present invention is shown in FIG. 6. An article, such as, but not limited to preform 3, is exposed to radiation 2 substantially in the near infrared region from radiation source 1. Suitable radiation sources include incandescent, quartz, halogen, arc lamps, metal oxide lamps, light emitting diodes, lasers and the like. For the purposes of this invention the near infrared region is extends from about 700 nm to about 2000 nm, and preferably from about 700 nm to about 1100 nm. It should be understood that other wavelengths of light may also be emitted by the radiation source, so long as a substantial portion is within the near infrared. Use of a light source that produces light only in the near infrared can enhance the contrast of the image to allow easier visualization of the defects without the use of the aforementioned optical filter and may be preferred in certain embodiments.

The radiation passes through and/or is returned from the article. This includes scattering, reflecting and transmitting. The absorbed radiation may be easily calculated by subtracting the passed and returned radiation from the radiation emitted by the radiation source. The passed and /or returned radiation 4 is measured by detector 5. Suitable detectors include electronic photodectors, such as photodiodes, thermal detectors, such as lead selenide detectors, linear detector arrays such as linear CCD CMOS arrays, electronic cameras wavelength sensitivity in the near infrared, such as charge-coupled device (CCD), charge injected device (CID), complementary metal oxide semiconductor (CMOS) based cameras and the like. Optical filters, not shown, that block the visible wavelengths but transmits near infrared wavelengths can optionally be used on the detector to provide greater contrast and easier identification of defects in articles and inspection of container contents. Suitable filters are known in the art and include but are not limited to colored glass or plastic absorption filters or interference filters, band pass or long wavelength pass filters, and the like. Filters can be used on the detector and/or the radiation source. Combinations of filters can also be used to enhance the separation of desired wavelengths of light (near infrared) from undesired (visible) wavelengths to achieve greater sensitivity. This can be accomplished by forming layers of filters consisting of, for example a colored glass and interference doublet.

The output from detector 5 may be processed in processing unit 7 to provide an image or process control data, which can be used to control the article forming or handling process 9. Where an image is desired processing unit 7 may be a simple video display, a video capturing card in a computer and the like. The processing unit may also be a computer that processes the image information and interfaces with or is incorporated into the control system for the processing or handling of the articles. Alternately, the processing unit may be an electronic indicator that would indicate defects and reject the defective article from the system.

The processing unit may be used to process the image for quality control purposes, such as quantitative determination of size and quantity of defects, verification and control of fill height, inspection of container contents for foreign objects and the like.

The present invention provides a quality control device for colored plastic articles and/or their contents that is simpler to use and install. The actual room needed to install an apparatus of the present invention is much less as well. In addition, the light source can be lower power LED's which do not adversely impact the plastic and can be mounted with the camera.

This invention can be further illustrated by the following examples of embodiments thereof, although it will be understood that these examples are included merely for purposes of illustration and are not intended to limit the scope of the invention unless otherwise specifically indicated. The invention has been described in detail with particular reference to preferred embodiments thereof, but it will be understood that variations and modifications can be effected within the spirit and scope of the invention.

### EXAMPLES

The examples listed below utilized a Marshal Electronics (Culver City, Calif.), part number V-1055 CCD camera for detector 5 attached to a computer (processing unit 7) via an imaging capturing card 6. A Rainbow H6 mm lens supplied by Marshall Electronics (Culver City, Calif.) part number V-4906R was attached to the camera. The images in the near infrared region were taken using a Corion LG-750 optical filter transmitting wavelengths longer than about 750 nm attached to the front of the lens. For comparative examples, the LG-750 filter was replaced by Corion LS-700 optical filter that transmits visible light but blocks wavelengths longer than 700 nm. Use of the Corion LS-700 filter in combination with the camera and lens provides images like those observed using the human eye. All images were obtained using a fiber optic illuminator using an Fostec 150 W incandescent light source (radiation source 1).

### Comparative Example 1

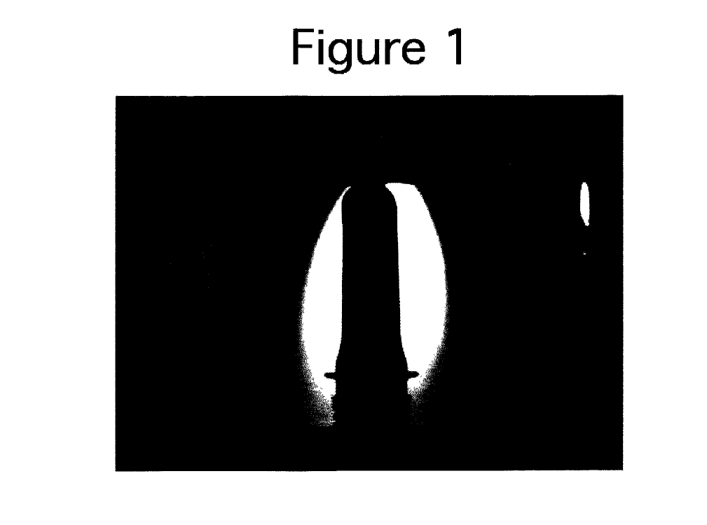

FIG. 1 was obtained using the camera, lens, and LS-700 filter described above. The article in the image appears defect-free and is an amber colored polyethylene terephthalate (AMBERGUARD, Eastman Chemical Company) preform (39 g, tapered, 250 mil thickness in the base section and 200 mil sidewall thickness (beer preform)). The image captured shows that the preform appears dark at visible wavelengths and the preform appears almost black to the human eye.

### Example 1

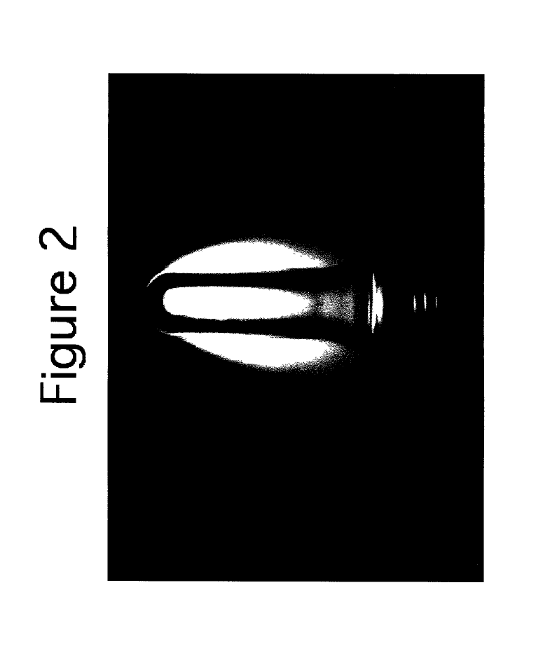

The preform imaged in Comparative Example 1 above was imaged again using the camera, lens, and LG-750 filter described above. The resultant image is shown in FIG. 2. The preform appeared transparent and displayed no defects.

### Comparative Example 2

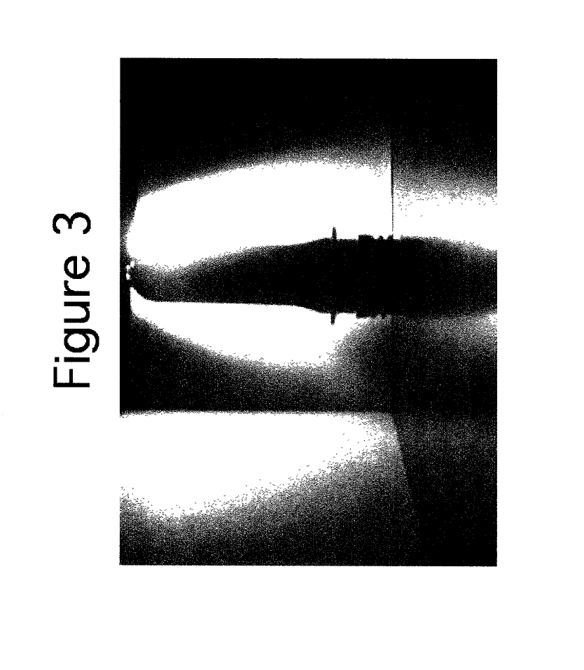

An amber colored preform was made according to Comparative Example 1, except that it contained containing particulates was imaged using the camera, lens, and LS-700 filter described above. The image is shown in FIG. 3 and shows a preform which appears almost black to the human eye. No defects are visible by the human eye or in the image.

### Example 2

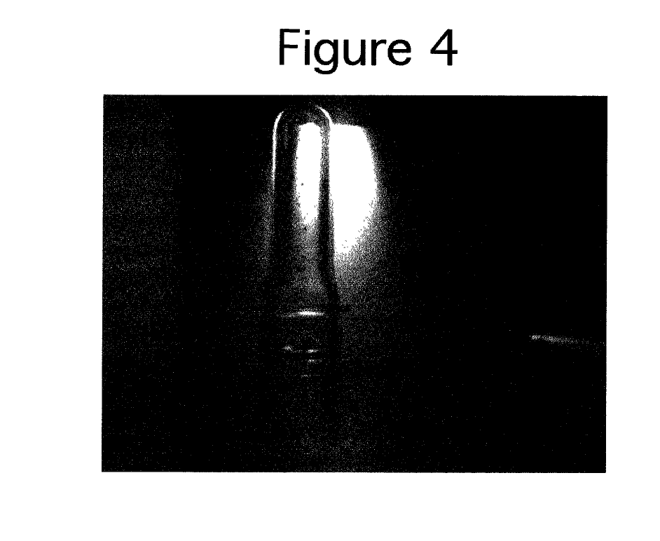

The preform imaged in Comparative Example 2 was imaged using apparatus of the present invention. The image is shown in FIG. 4. The image rendered by the apparatus and method of the present invention clearly shows particulate defects in the preform, which were not discernable in the visible range.

### Comparative Example 3

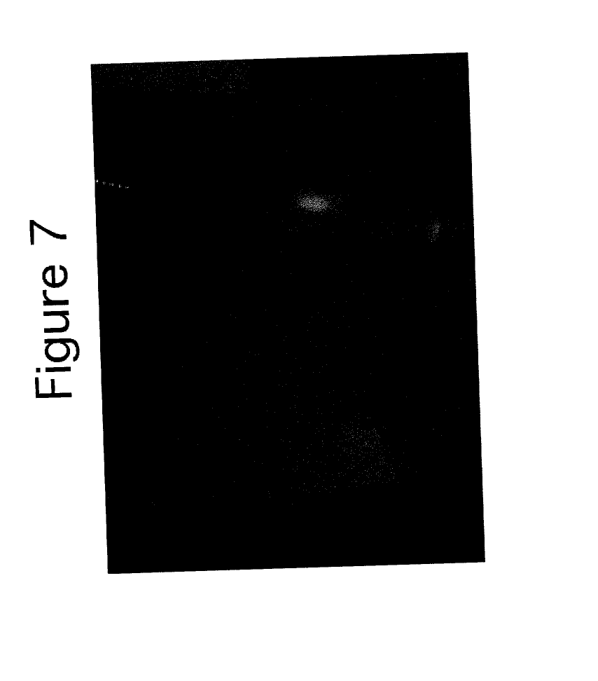

An amber preform of the same polymer as Comparative Example 1 but having crystalline haze and a large void was imaged in the visible range using the camera, lens, and LS-700 filter described above. The image is shown in FIG. 7. The resultant image showed a preform that appeared almost black to the human eye. No defects were visible and the void was only slightly visible in this image.

### Example 3

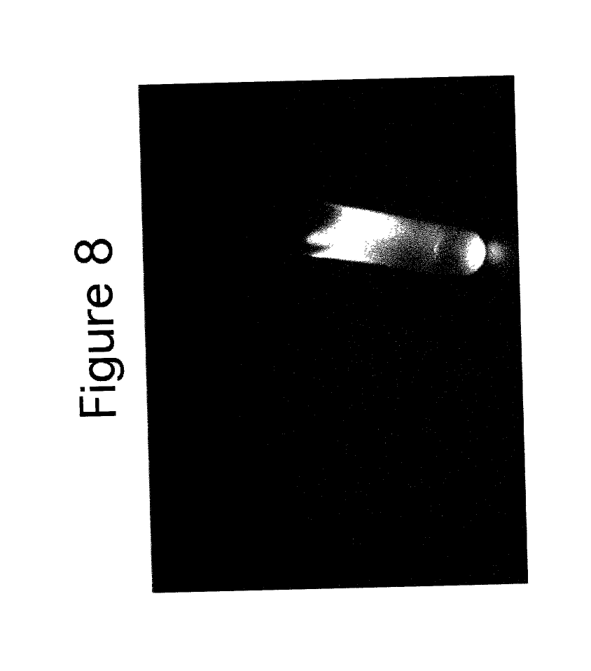

The preform imaged in Comparative Example 3 was imaged again using the camera, lens, and LG-750 filter described above. The resultant image (FIG. 8) captured clearly shows a large void defect, which is visible as a shaded “sphere” at the bottom of the preform and crystalline haze, which looks like a milky haze in the image.

### Comparative Example 4

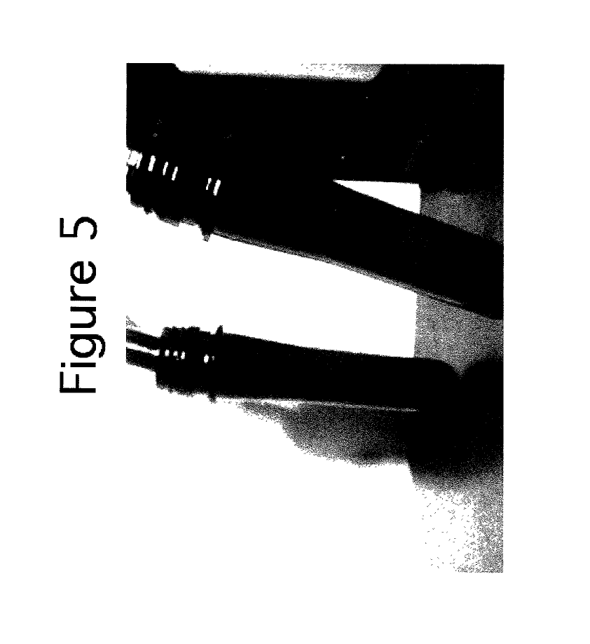

Two amber preforms of the same polymer as Comparative Example 1 (one haze-free and one containing haze) were imaged using the camera, lens, and LS-700 filter described above. The image is shown in FIG. 5. The preforms appeared dark and almost black to the human eye. No defects are visible to the human eye in either preform and none are captured in the image.

### Example 4

The two preforms imaged in Comparative Example 4 were imaged using the method and apparatus of the present invention the camera, lens, and LG-750 filter described above). The resultant image is shown at FIG. 6. In the image, the preform on left is can be seen to be of good quality and defect free while crystalline haze is observed in the preform on the right. In Comparative Example 4, these preforms were virtually indistinguishable. However, using the present invention, it is clear that there is a substantial difference in haze. These Examples clearly show the surprising improvement provided by the present invention.

### Example 5

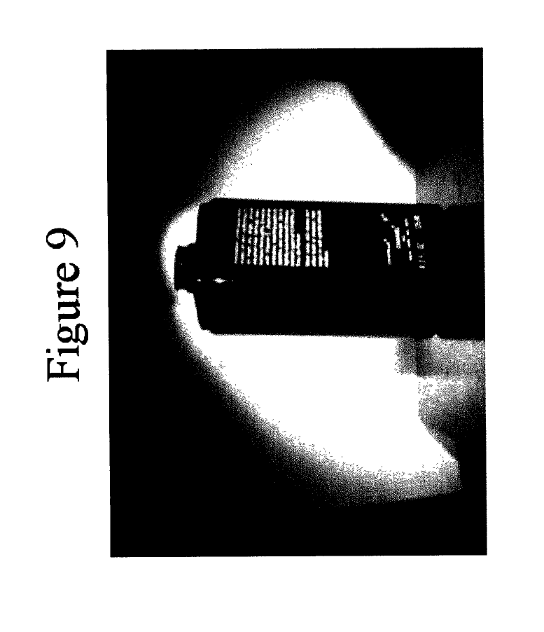

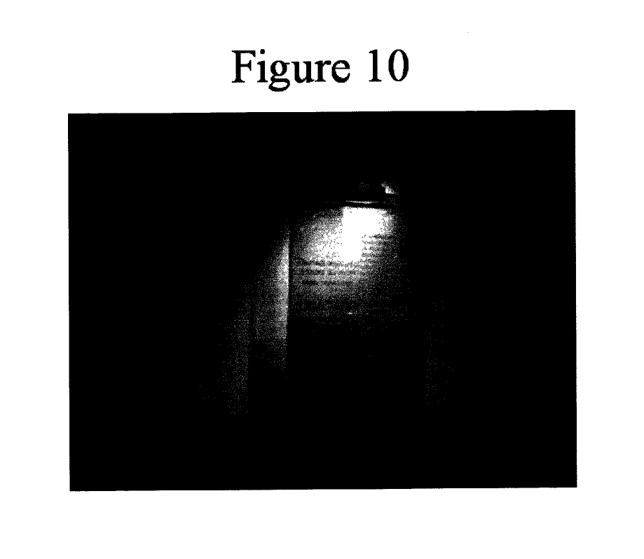

A black personal care container [125 ml, 4.2 fl oz, height of 7⅛″, width of 2¼″, amorphous PET] was imaged using the camera, lens, and LS-700 filter described above (visible region) and the camera, lens, and LG-750 filter (present invention). The images are shown in FIGS. 9 and 10, respectively. FIG. 9a shows a container that appears dark at visible wavelengths and the water inside is not visible either to the human eye or in the image. However, in FIG. 10 the container is transparent and the water level is clearly visible.

### Example 6

A non-colored 16 oz. polyester container (12 mill sidewall thickness), containing cola carbonated beverage was observed using the camera, lens, and LS-700 filter (visible region) and the camera, lens, and LG-750 filter (present invention). The contents of the container appeared dark on the monitor and almost black to the human eye in the visible region. However, the contents of the container could be inspected for contaminates and objects on the opposite side of the container were visible when imaged in the near infrared range in accordance with the present invention.

We claim:

1. A method comprising:
exposing a plastic colored article to radiation in the near infrared range; measuring radiation returned from or passed through said article and analyzing said returned or passed radiation to provide defect data for said article or contents within said article.

2. The method of claim 1 wherein said near infrared range is between about 700 nm and about 2000 nm.

3. The method of claim 1 wherein said near infrared range is between about 700 nm to about 1100 nm.

4. The method of claim 1 where said defect data comprises data selected from the group consisting of haze, unmelts, bubbles, voids, specks, particulates, termination of internal layers in a multilayer structure, holes of internal layers in a multilayer structure, content fill level and foreign objects in contents.

5. The method of claim 1 wherein said measuring step is performed by an electronic camera.

6. The method of claim 1 further comprising the step of using said defect data to control or adjust process conditions for forming said article.

7. The method of claim 1 further comprising the step of using said defect data to reject articles having unacceptable levels of defects therein.

8. The method of claim 1 wherein said radiation is pulsed to provide spatially undistorted data.

9. The method of claim 1 wherein said plastic is selected from the group consisting of include polyesters, polyolefins, nylons, polystyrenes, polycarbonates, ethylene-vinyl acetate copolymer (EVOH), polyalcohol ethers, wholly aromatic polyesters, resorcinol diacetic acid-based copolyesters, polyalcohol amines, isophthalate containing polyesters, PEN and its copolymers, mixtures, copolymers and multilayers thereof.

10. The method of claim 9 wherein said plastic comprises at least one polyester.

11. The method of claim 1 wherein said article is selected from the group consisting of polymer pellets, reactor strands, reactor contents, parisons, performs, bottles, containers, film, sheet, fibers, thermoformed articles, injection molded parts, extruded profiles, pipe and container contents.

12. The method of claim 11 wherein said article is selected from the group consisting of preforms, containers, bottles and container contents.

13. The method of claim 11 wherein said article is selected from the group consisting of preforms and containers.

14. The method of claim 11 wherein said article comprises container contents selected from the group consisting of colas, teas, coffee, motor oil, jellies, soy sauce.

15. The method of claim 1 wherein said colored article transmits less than about 25% of light across the range of about 400 nm to about 700 nm

16. An apparatus comprising;
a near infrared radiation source positioned to emit radiation at a colored article; and
a detector positioned to measure radiation returned from or passed through said colored article.

17. The apparatus of claim 16 further comprising a processing unit capable of providing an image or process control data.

18. The apparatus of claim 16 wherein said radiation source is selected from the group consisting of incandescent lamps, quartz lamps, halogen lamps, arc lamps, metal oxide lamps, light emitting diodes and lasers.

19. The apparatus of claim 16 wherein said radiation source emits radiation between about 700 nm to about 2000 nm.

20. The apparatus of claim 16 wherein said radiation source emits radiation between about and preferably from about 700 nm to about 1100 nm.

21. The apparatus of claim 16 wherein said detectors is selected from the group consisting of electronic photodetectors, thermal detectors, linear detector arrays and electronic cameras with wavelength sensitivity in the near infrared.

22. The apparatus of claim 16 further comprising optical filters that block visible wavelengths but transmits near infrared wavelengths and are used with the radiation source, detector or both.

23. The apparatus of claim 17 wherein said process control data is used to control a process for forming or handling said article.

24. A method comprising:
exposing a plastic article having colored contents contained therein to radiation in the near infrared range; measuring radiation returned from or passed through said article and contents and analyzing said returned or passed radiation to provide defect data for said article or contents within said article.
